(19) United States
(12) Patent Application Publication
(10) Pub. No.: US 2011/0037617 A1
(43) Pub. Date: Feb. 17, 2011

(54) SYSTEM AND METHOD FOR PROVIDING VEHICULAR SAFETY SERVICE

(75) Inventors: Jeong Ah JANG, Daejeon (KR); Hae Sook Jeon, Daejeon (KR); Hyunsuk Kim, Daejeon (KR); Kyong Ho Kim, Daejeon (KR); Daesub Yoon, Daejeon (KR); Jong-woo Choi, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/856,237

(22) Filed: Aug. 13, 2010

(30) Foreign Application Priority Data
Aug. 14, 2009 (KR) 10-2009-0075422
May 25, 2010 (KR) 10-2010-0048834

(51) Int. Cl. G08G 1/0967

(52) U.S. Cl. 340/905

(57) ABSTRACT

A local server of a system for providing a vehicular safety service receives road surface state information of each zone of the road in a service area from at least one road sensor located in the service area to calculate a road safety coefficient of each zone, and receives location information and running information of a vehicle from at least one vehicle terminal located in the service area to calculate a traffic flow analysis coefficient. The local server provides a vehicular safety service to a vehicle terminal by using the road safety coefficient of each zone and the traffic flow analysis coefficient.

### CROSS-REFERENCE TO RELATED APPLICATION

This application claims priority to and the benefit of Korean Patent Application Nos. 10-2009-0075422 and 10-2010-0048834 filed in the Korean Intellectual Property Office on Aug. 14, 2009 and May 25, 2010, the entire contents of which are incorporated herein by reference.

### BACKGROUND OF THE INVENTION

(a) Field of the Invention

The present invention relates to a system and method for providing a vehicular safety service.

(b) Description of the Related Art

An increase in the number of vehicles raises the risk of collision between vehicles on the road, so a safe distance must be secured between vehicles for safe operation of vehicles. However, there is a limitation for a driver to maintain a safe distance from a vehicle ahead by the naked eye.

Thus, the related art inter-vehicle distance alarm system helps a driver keep a safe distance from the vehicle ahead at a certain speed, thus reducing the possibility of an accident. However, in order for the driver (i.e., user) to be provided with the inter-vehicle distance alarm system, he must attach an inter-vehicle distance sensor that is able to calculate a safe distance from the vehicle ahead to his vehicle.

In addition, the safe distance from the vehicle ahead is greatly affected by the road surface according to climate or weather. In this respect, however, the inter-vehicle distance alarm system does not consider the state of the road surface that varies according to weather, generating numerous errors with respect to the inter-vehicle safe distance.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a system and method for providing a vehicular safety service having advantages of providing a vehicular safety service even to vehicles not having an inter-vehicle distance sensor and reducing an error of an inter-vehicle safe distance with regard to climate or weather.

An exemplary embodiment of the present invention provides a method for providing a vehicular safety service to a vehicle terminal of a vehicle located on a road within a service area from a local server. The method for providing a vehicular safety service includes: receiving road surface state information of each zone of the road in the service area from a road sensor; receiving location information and running information from the vehicle terminal; estimating an inter-vehicle safe distance situation based on the road surface status information of each zone of the road, the location information, and running information from the vehicle terminal; and if an inter-vehicle safe distance is determined to be inadequate according to the inter-vehicle safe distance situation, transmitting safe distance risk information to the vehicle terminal.

Another embodiment of the present invention provides a system for providing a vehicular safety service to a plurality of vehicle terminals installed in a plurality of vehicles, respectively, located in a service area. The system for providing a vehicular safety service may include a road sensor processing unit, a vehicle information processing unit, a safety determining unit, and an information providing unit. The road sensor processing unit may receive road surface state information of each zone of the road in the service area from at least one road sensor located in the service area, and may calculate a road safety coefficient of each zone by using the road surface state information of each zone of the road. The vehicle information processing unit may calculate a traffic flow analysis coefficient of the service area based on location information and running information received from each of the plurality of vehicle terminals. The safety determining unit may estimate a safe distance of each vehicle by using the road safety coefficient of each zone and the traffic flow analysis coefficient, and may determine a vehicle that has inadequate safe distance based on the estimated vehicle safe distance situation of each vehicle. The information providing unit may provide safe distance risk information to the vehicle that has inadequate safe distance.

According to exemplary embodiments of the present invention, an inter-vehicle safe distance situation is determined by using a road surface state of the road and location information as well as running information of a vehicle, and an alarm message is provided to a pertinent vehicle so the driver can keep a safe distance, thus helping prevent an accident.

In particular, an alarm message can be provided to a driver of a vehicle without an inter-vehicle distance sensor, and because a road surface state with regard to climate or weather is taken into consideration, an error in determining an inter-vehicle safe distance situation can be reduced.

In addition, the flow of vehicles can be monitored by using safe distance situation information reflecting a road surface state of the road with regard to climate or weather, and thus the road can be managed more effectively.

### BRIEF DESCRIPTION OF THE DRAWINGS

FIG. 1 is a schematic block diagram of a system for providing a vehicular safety service according to an exemplary embodiment of the present invention.

FIG. 2 illustrates an environment to which the vehicular safety service providing system according to an exemplary embodiment of the present invention is applied.

FIG. 3 illustrates location information of each zone in a detection area.

FIG. 4 is a schematic block diagram of a local server illustrated in FIG. 1.

FIG. 5 illustrates how location information is converted according to a first exemplary embodiment of the present invention.

FIG. 6 schematically shows a location conversion unit for converting location information according to the first exemplary embodiment of the present invention.

FIG. 7 illustrates how location information is converted according to a second exemplary embodiment of the present invention.

FIG. 8 is a flowchart illustrating the process of a method for providing a vehicular safety service according to an exemplary embodiment of the present invention.

FIG. 9 is a graph for determining whether or not a distance is unsafe according to a road safety coefficient and a traffic flow analysis coefficient.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising” will be understood to imply the inclusion of stated elements but not the exclusion of any other elements.

A system and method for providing a vehicular safety service according to exemplary embodiments of the present invention will now be described with reference to the accompanying drawings.

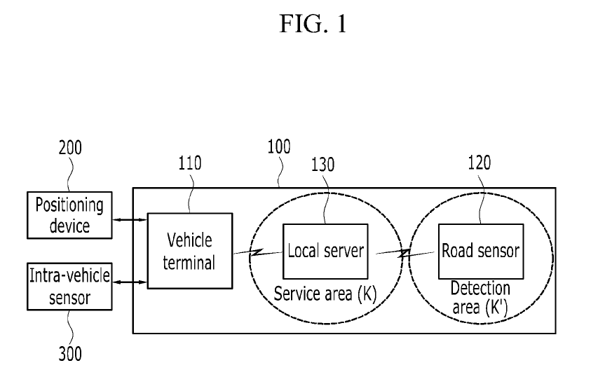

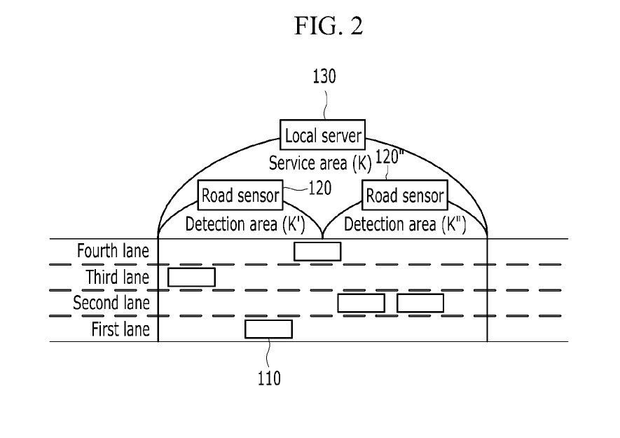

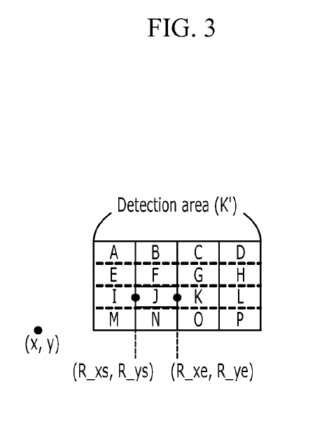

FIG. 1 is a schematic block diagram of a system for providing a vehicular safety service according to an exemplary embodiment of the present invention, and FIG. 2 illustrates an environment to which the vehicular safety service providing system according to an exemplary embodiment of the present invention is applied. FIG. 3 illustrates location information of each zone in a detection area. In FIG. 2, only a single local server is illustrated for the sake of brevity.

With reference to FIGS. 1 and 2, a vehicular safety service providing system 100 includes a vehicle terminal 110, a road sensor 120, and a local server 130.

The vehicle terminal 110, which is a terminal mounted in a vehicle that runs on the road, performs radio communication with the local server 130 that administers a service area (K) within the service area (K). The vehicle terminal 110 gathers location information and running information of the vehicle from a positioning device 200 that measures the location of the vehicle and an intra-vehicle sensor 300 that measures the running information of the vehicle in real time, respectively, and delivers the gathered location information and running information of the vehicle to the local server 130. Here, the location information of the vehicle may include a vehicle ID and absolute coordinate location information, and the running information may include a vehicle ID, acceleration and deceleration information, speed information, fuel consumption information, breakdown information, and the like, that is, internal vehicular information. The positioning device 200 may include satellite navigation systems such as a global positioning system (GPS) and a global navigation satellite system (GNSS), or a gyro sensor, and the like. The vehicle terminal 110 may be connected with the positioning device 200 and the intra-vehicle sensor 300 through OBD-II (On Board Diagnostics version II).

When the vehicle terminal 110 receives safe distance risk information of the vehicle from the local server 130, it provides the received safe distance risk information to the driver. In this case, the vehicle terminal 110 may provide the safe distance risk information in the form of a message or sound.

The road sensor 120 performs radio communication with the local server 130, detects a road surface state of each zone of the road in the detection area (K′), and delivers road surface state information of each zone of the road to the local server 130. Here, the road surface state information may include a frozen state resulting from snow or freezing rain, a water screen state, a dry state, a wet state, fog, and the like.

The road sensor 120 retains reference relative location coordinates mapped to single reference absolute location coordinates, and discriminates a zone in a detection area K′ by using relative location coordinate information based on the reference relative location coordinates. In this case, the relative location coordinate information is obtained by measuring a central point of a vertical length of a zone, or it may be obtained by measuring a point of the diagonal corner of the zone. The road sensor 120 delivers relative location coordinate information of each zone and road surface state information of a corresponding zone to the local server 130. That is, when the detection area K′ is divided into a plurality of zones A˜P as shown in FIG. 3, relative location coordinate information of each of the respective zones A˜P may be represented as absolute location coordinate information based on absolute location coordinates (x, y) through the relationship with reference relative location coordinates (X, Y). For example, the relative location coordinate information of a zone J can be represented as {(R_xs, R_ys), (R_xe, R_ye)} based on the reference relative location coordinates (X, Y). Also, the relative location coordinates {(R_xs, R_ys), (R_xe, R_ye)} of the zone J may be converted into absolute location coordinate information based on the ratio in which the reference relative location coordinates (X, Y) are converted into the reference absolute location coordinates (x, y). One or more road sensors 120 may exist within the service area K administered by the local server 130 according to the size of the detection area K′ of the road sensor 120. For example, when the detection area K′ of the road sensor 120 is the same as the service area K of the local server 130, the local server 130 can receive road surface state information of every zone in the service area through only the single road sensor 120, so the single road sensor 120 will be sufficient. However, if the detection area K′ of the road sensor 120 is smaller than the service area K of the local server 130, the local server 130 cannot receive road surface state information of every zone in the service area K with only single road sensor 120. Thus, when the detection area K′ of the road sensor 120 is smaller than the service area K of the local server 130, the vehicular safety service providing system 100 may include two or more road sensors 120 and 120″ having different detection areas K′ and K″ in the service area K.

The local server 130 is installed at the roadside of the road, and performs radio communication with the vehicle terminal 110 and the road sensor 120.

The local server 130 receives road surface state information of each zone of the road within the service area K from the road sensor 120, and receives location information of the vehicle and running information of the vehicle within the service area K from the vehicle terminal 110. The local server 130 provides a vehicular safety service to the vehicle terminal 110 by using the information that has been received from the vehicle terminal 110 and the road sensor 120. In particular, the local server 130 estimates a situation of a safe distance between the vehicle and a vehicle ahead (i.e., a preceding vehicle) and between the vehicle and a vehicle behind (i.e., a following vehicle) (the situation will be referred to as an “inter-vehicle safe distance situation”, hereinafter) by using the information that has been received from the vehicle terminal 110 and the information that has been received from the road sensor 120. If the inter-vehicle distance is determined to be inadequate, the local server 130 generates safe distance risk information and provides it to the vehicle terminal 110. In this case, the service area K administered by the local server 130 may be set to be a few meters to a few kilometers.

The vehicular safety service providing system 100 can be installed on uninterrupted flow facilities (i.e., uninterrupted flow road) as shown in FIG. 2. That is, the vehicular safety service providing system 100 may be applicable to a relatively linear road with a small vertical alignment or a curved road with a small curve degree so as to be suitable for a high speed running operation. Further, the vehicular safety service providing system 100 can be applicable to other roads.

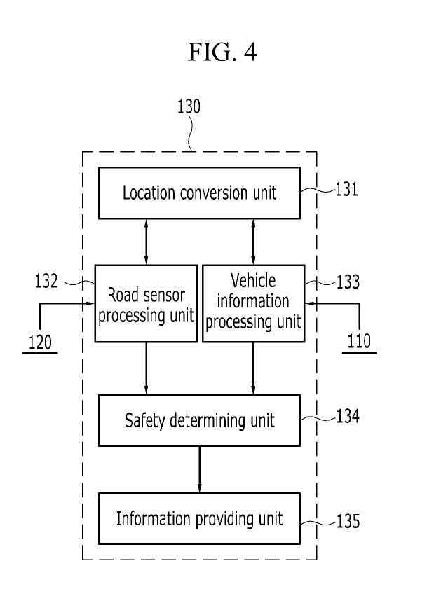

FIG. 4 is a schematic block diagram of a local server illustrated in FIG. 1.

With reference to FIG. 4, the local server 130 includes a location conversion unit 131, a road sensor processing unit 132, a vehicle information processing unit 133, a safety determining unit 134, and an information providing unit 135.

The location conversion unit 131 converts at least one of location information of the vehicle received from the vehicle terminal 110 and location information of each zone within the detection area K′ of the road surface state information received from the road sensor 120. That is, the location information of the vehicle is absolute location information such as longitude and latitude coordinates. However, the location information of each zone within the detection area K′ with respect to the road surface state information is relative location information. Thus, the location conversion unit 131 converts at least one of the location information of the vehicle and the location information of each zone within the detection area K′ in order to standardize the unit of the location information of the vehicle and the location information of each zone within the detection area K′ of the road surface state information.

The road sensor processing unit 132 receives the road surface state information of each zone of the road within the service area K from the road sensor 120, calculates a safety coefficient of each zone by using the received road surface state information of each zone, and delivers the safety coefficient information of each zone to the safety determining unit 134. In this case, the road sensor processing unit 132 delivers the location information of each zone within the service area K to the location conversion unit 131, and calculates the safety coefficient according to the location information, which has been converted by the location conversion unit 131, of each zone.

The vehicle information processing unit 133 receives the location information and the running information of the vehicle from the vehicle terminal 110 located in the service area K, determines whether or not the vehicle maintains its lane by using the received location information of the vehicle, and determines a situation of a vehicle ahead of the vehicle running on the lane, while maintaining the lane, and a vehicle behind the vehicle running on the lane. In this case, the vehicle information processing unit 133 may deliver the location information of the vehicle to the location conversion unit 131 and determine whether or not the vehicle maintains its lane by using location information, which has been converted by the location conversion unit 131, of the vehicle.

Thereafter, the vehicle information processing unit 133 delivers the vehicle information including the running information of the vehicle, the information regarding whether or not the vehicle maintains its lane, and information regarding whether or not there is a vehicle ahead or behind, to the safety determining unit 134. Also, the vehicle information processing unit 133 calculates a traffic flow analysis coefficient with respect to the service area K by using the location information of the vehicle and the running information of the vehicle that have been received from the vehicle terminal 110 located in the service area K, and delivers the calculated traffic flow analysis coefficient to the safety determining unit 134. In this case, the traffic flow analysis coefficient denotes information regarding traffic of each time zone with respect to the service area K, and average information of speed and density.

The road sensor processing unit 132 and the vehicle information processing unit 133 deliver the location information of each zone within the service area and the location information of the vehicle to the location conversion unit 131, respectively, and then receive converted location information from the location conversion unit 131, respectively.

The safety determining unit 134 estimates an inter-vehicle safe distance situation by using the safety coefficient information of each zone within the service area K that has been received from the road sensor processing unit 132, the traffic flow analysis coefficient information with respect to the service area K that has been received from the vehicle information processing unit 133, and the vehicle information. Then, when the inter-vehicle distance is determined to be inadequate based on the inter-vehicle safe distance situation information, the safety determining unit 134 generates safe distance risk information and delivers the same to the information providing unit 135.

Upon receiving the safe distance risk information from the safety determining unit 134, the information providing unit 135 provides the safe distance risk information to the vehicle terminal 110 of the pertinent vehicle.

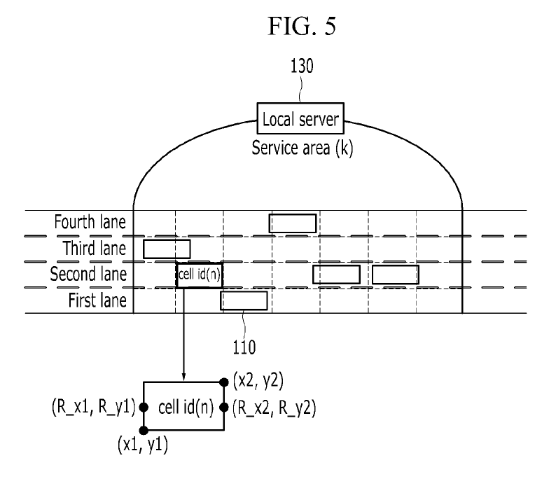

A method for converting the location information by the location information conversion unit 131 will now be described in detail with reference to FIGS. 5 to 7.

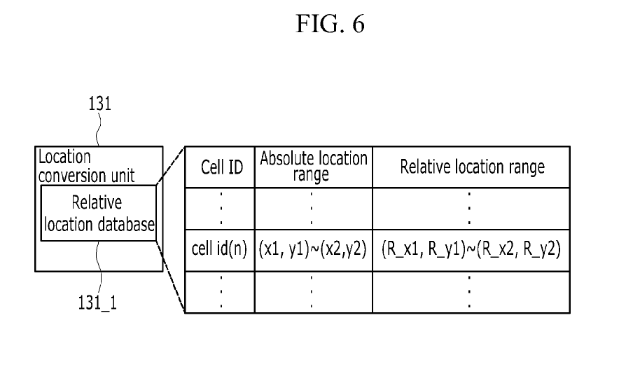

FIG. 5 illustrates how location information is converted according to a first exemplary embodiment of the present invention, and FIG. 6 schematically shows a location conversion unit for converting location information according to the first exemplary embodiment of the present invention.

As shown in FIG. 6, the location conversion unit 131 may include a relative location database 131_1 storing relative location information with respect to the service area K. In this case, a cell ID may be used as the relative location information. That is, when the service area K is divided into a plurality of cells as shown in FIG. 5, each cell may be identified by a cell ID, and the relative location database 131_1 may store relative location information in the form of a cell ID, an absolute location range, and a relative location range by the cells. For example, when a cell ID is a cell id(n), the relative location database 131_1 may store the relative location information, regarding the service area K, in the form of [cell id(n), {(x1, y1), (x2, y2)}, and {(R_x1, R_y1), (R_x2, R_y2)}]. That is, the cell having the cell ID of “cell id(n)” is the region between absolute coordinates (x1, y1) and (x2, y2) and between relative coordinates (R_x1, R_y1) and (R_x2, R_y2). Here, x1 and x2 are longitude coordinates, and y1 and y2 are latitude coordinates. Thus, the location conversion unit 131 can convert the location information of the vehicle into a cell ID and can also convert the location information in a zone within the detection area K′ to a cell ID by using the relative location database 131_{—1}.

Meanwhile, the physical length of the vertical axis of each cell, that is, a vertical section, may be limited by the width of the lane. In this case, the vertical section of each zone within the detection area may equal to or smaller than a vertical section of each cell. Also, a physical length of a horizontal axis of each cell, that is, a horizontal section, may be set to be different according to elaboration of a service and an error range of absolute location information. For example, when an error of the absolute location information is 5 m, the horizontal section of each cell may be set to be 5 m or larger. Also, when an average speed of the vehicle is 100 km/h, the vehicle runs 28 m per second. In this case, when a target service reaction requirement value that corresponds to the elaboration of the service is 0.5 seconds, the horizontal section of each cell may be set to be within 14 m. In addition, when an average speed is 50 km/h, the vehicle runs 14 m per second. Thus, when the target service reaction requirement value is 0.5 seconds, the horizontal section of each cell may be set to be within 7 m. Here, the target service reaction requirement value includes a time required for the vehicular safety service according to an exemplary embodiment of the present invention to start to be provided to the driver and then the driver to react thereto. The target service reaction requirement value refers to an instantaneous movement time during which the vehicle runs without being provided with information, and the vehicle runs a certain distance at a constant velocity during the instantaneous movement time. That is, when a distance concept according to the running speed of the vehicle is considered, the vehicle runs a distance of “target service reaction requirement value×average vehicle speed (m/s)” at a constant velocity. Thus, the horizontal section of each cell can be set according to the relationship between an error of the absolute location information, that is, an error of the horizontal section, and the target service reaction requirement value. As a result, the horizontal section of each cell can be set as follows.

Horizontal section of cell=absolute error range (m)=unit length (m) of horizontal axis of cell ID=target service reaction requirement value (s)×average vehicle speed (m/s).

Meanwhile, it may occur that the information of the relative location database 131_1 cannot be used due to the relationship between the error of the absolute location information and the target service reaction requirement value. When the information of the relative location database 131_1 cannot be used, the location conversion unit 131 may directly convert location information of each zone within the detection area K′ into an absolution location.

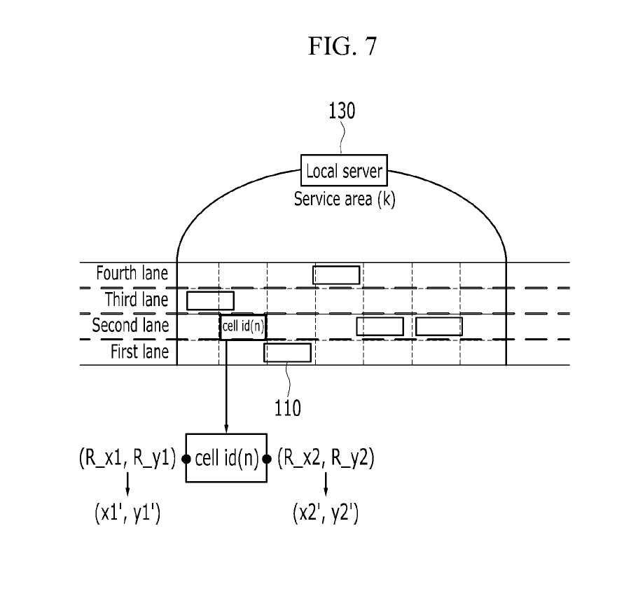

FIG. 7 illustrates how location information is converted according to a second exemplary embodiment of the present invention.

With reference to FIG. 7, the location conversion unit 131 may directly convert the relative location information of each zone within the detection area K′ into an absolute location. That is, the location conversion unit 131 stores reference absolute location coordinates and reference relative location coordinates of the road sensor 120, and converts location information of each zone within the detection area K′ according to the relationship between the reference relative location coordinates and the reference absolute location coordinates. For example, the location conversion unit 131 may convert the is relative location coordinates (R_x1, R_y1) and (R_x2, R_y2) of the cell having the cell ID of “cell id(n)” into (x1′, y1′) and (x2′, y2′) through the relationship between the reference relative location coordinates and the reference absolute location coordinates. When location information of each zone within the detection area K′ is converted into absolution location information in this manner, the location information of the vehicle does not need to be additionally converted.

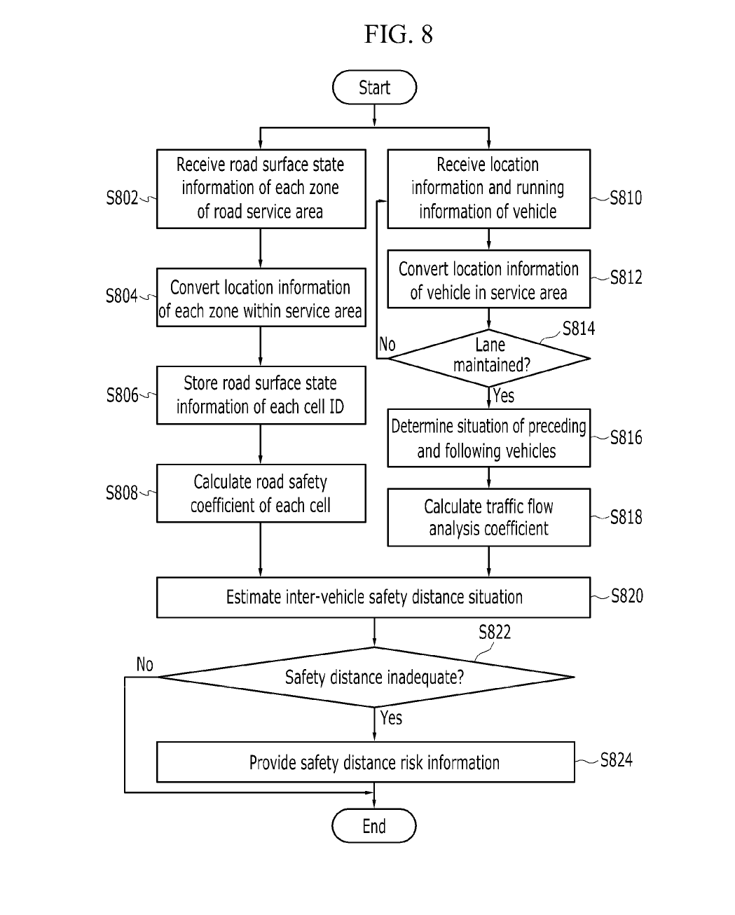

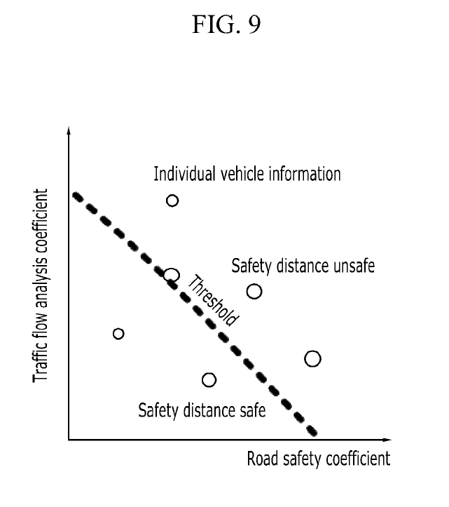

FIG. 8 is a flowchart illustrating the process of a method for providing a vehicular safety service according to an exemplary embodiment of the present invention, and FIG. 9 is a graph for determining whether or not a distance is unsafe according to a road safety coefficient and a traffic flow analysis coefficient.

With reference to FIG. 8, the road sensor processing unit 132 receives road surface state information of each zone of the road within the service area K from the road sensor 120 (S802).

The road sensor processing unit 132 delivers the location information of each zone within the service area K to the location conversion unit 131. The location conversion unit 131 then maps the location information of each zone within the service area K to the relative location database 131_1 to convert it into a cell ID and delivers the converted cell ID to the road sensor processing unit 132 (S804). Meanwhile, when the location conversion unit 131 does not use the relative location database 131_1, the location conversion unit 131 may directly convert location information of each zone within the service area K into absolute location information and deliver the converted absolute location information to the road sensor processing unit 132.

The road sensor processing unit 132 stores the road surface state information of the road of each cell ID. Then, the road sensor processing unit 132 calculates a road safety coefficient of each cell ID by using the road surface state information of the road of each cell ID (S808) and delivers the calculated road safety coefficient information of each cell ID to the safety determining unit 134. In this case, the road safety coefficient can be calculated as follows.

Road safety coefficient={cell ID,f(road state information)}

Here, the f(road state information) refers to a value such as a road friction coefficient or the like according to the road state. The road friction coefficient may vary depending on the speed of a vehicle, a tire abrasion state, a kind of paved road surface, and a road surface state. The road friction coefficient value may greatly differ according to a road state even though vehicles run at the same speed. Thus, the road sensor processing unit 132 calculates the road safety coefficient in consideration of the friction coefficient of the road surface that varies according to the road state information. Here, the road friction coefficient may be configured in the form of a table based on general experimentation values, or may be configured in the form of a numerical formula based on an estimate value.

Also, the vehicle information processing unit 133 receives the location information of the vehicle and the running information of the vehicle from the vehicle terminal 110 located within the service area K (S810).

The vehicle information processing unit 133 delivers the location information of the vehicle located within the service area K to the location conversion unit 131, and the location conversion unit 131 maps the location information of the vehicle within the service area K to the relative location database 131_1 to convert it into a cell ID of the vehicle and delivers the converted cell ID to the vehicle information processing unit 133 (S812).

The vehicle information processing unit 133 determines whether or not whether the vehicle maintains its lane based on the location information of the cell ID (S814). That is, the vehicle information processing unit 133 determines whether or not the information regarding the lane of the vehicle is maintained to be the same as that of a previous time (S814). In this case, when the vehicle runs while maintaining the same lane as that of the previous time, the vehicle information processing unit 133 determines the situation of a preceding vehicle and a following vehicle based on the location information of the cell ID of the vehicle (S816). Meanwhile, if the vehicle runs a different lane from that of the previous time, it waits until such time as location information of the vehicle is gathered during a next period, and then the steps are repeatedly performed (S810 to S814).

Also, the vehicle information processing unit 133 calculates a traffic flow analysis coefficient with respect to the service area K by using the location information of the vehicle and the running information of the vehicle (S818). That is, the vehicle information processing unit 133 obtains a traffic flow analysis coefficient by compiling statistics of the speed of the vehicle according to a vehicle location, acceleration and deceleration information, and the like. Thereafter, the vehicle information processing unit 133 delivers the vehicle information of the vehicle located within the service area K and the traffic flow analysis coefficient information to the safety determining unit 134. This sequential process is performed at every period, e.g., at certain time intervals, for each vehicle. In this case, the period may be set by the hour or minute.

Meanwhile, when the location conversion unit 131 does not use the relative location database 131_1, the vehicle information processing unit 133 may determine whether or not the vehicle maintains its lane by using the relationship between the location information of each zone within the service area K and the location information of the vehicle. In detail, as shown in FIG. 7, the relative location coordinates (R_x1, R_y1) and (R_x2, R_y2) of the cell having the cell ID of “cell id(n)” are converted into (x1′, y1′) and (x2′, y2′). In this case, when the vehicle has the location information of (x1, y1) and (x2, y2), the vehicle information processing unit 133 determines whether or not the vehicle maintains its lane based on a value |y1′−y1|. If the value |y1′−y1| is smaller than the width of the lane, the vehicle information processing unit 133 determines that the vehicle runs the same lane, or otherwise, the vehicle information processing unit 133 determines that the vehicle runs a different lane. Meanwhile, a zone having a corresponding road surface state and a relative distance of the vehicle can be calculated from the value |y1′−y1|.

Next, the safety determining unit 134 estimates an inter-vehicle safe distance situation by using the road safety coefficient information of each zone within the service area K, the traffic flow analysis coefficient with respect to the service area K, and the vehicle information of the vehicle (S820).

If the safety determining unit 134 determines that the inter-vehicle distance is inadequate based on the estimated safe distance situation information (S822), the safety determining unit 134 generates safe distance risk information and provides the generated safe distance risk information to the vehicle terminal 110 through the information providing unit 135 (S824). In this case, the safety determining unit 134 may determine whether or not the inter-vehicle distance is inadequate based on the data illustrated in FIG. 9

That is, the local server 130 periodically calculates the vehicle information of the vehicle located within the service area K and the traffic flow analysis coefficient. In this case, when the local server 130 receives road surface state information “frozen” of the cell having the cell ID of “cell id(n)” from the road sensor 120, the local server 130 calculates a safe distance threshold value based on the road surface state information “frozen”, the vehicle information of the vehicle, and the traffic flow analysis coefficient, and compares an actual distance between the preceding and following vehicles based on the location information of the preceding and following vehicles and the safe distance threshold value, thereby determining whether or not the distance is inadequate.

Thereafter, when the vehicle terminal 110 receives the safe distance risk information from the information providing unit 135, the vehicle terminal provides the received safe distance risk information to the driver of the vehicle, thus preventing a dangerous situation or an accident from occurring.

The exemplary embodiments of the present invention are not implemented only through the foregoing device and/or method, but may be implemented through a program realizing the function corresponding to the configuration of the exemplary embodiments of the present invention or a recording medium storing the program. Such implementation may be easily made by the skilled person in the art to which the present invention pertains from the description of the foregoing exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for providing a vehicular safety service to a vehicle terminal of a vehicle located on a road in a service area from a local server, the method comprising:
receiving road surface state information of each zone of a road in the service area from a road sensor;
receiving location information and running information from the vehicle terminal;
estimating an inter-vehicle safe distance situation based on the road surface status information of each zone of the road, the location information, and running information from the vehicle terminal; and
if an inter-vehicle safe distance is determined to be inadequate according to the inter-vehicle safe distance situation, transmitting safe distance risk information to the vehicle terminal.

2. The method of claim 1, wherein the estimating of the inter-vehicle safe distance situation comprises:
calculating a road safety coefficient of each zone using the road surface state information of each zone of the road;
calculating a traffic flow analysis coefficient of the service area by using the location information and running information of the vehicle terminal; and
estimating an inter-vehicle safe distance situation by using the road safety coefficient of each zone and the traffic flow analysis coefficient.

3. The method of claim 2, wherein the estimating of the inter-vehicle safe distance situation further comprises
determining whether or not a lane is maintained and a situation of preceding and following vehicles by using the location information of the vehicle terminal,
wherein the inter-vehicle safe distance situation is estimated by using the additional information regarding whether or not the lane is maintained and the information regarding the situation of the preceding and following vehicles.

4. The method of claim 3, wherein the determining of whether or not the lane is maintained and the situation of the preceding and following vehicles comprises:
determining whether or not the lane is maintained by using the location information of the vehicle terminal; and
when the vehicle runs the same lane as that of a previous time, determining the situation of the preceding and following vehicles.

5. The method of claim 2, wherein the calculating of the road safety coefficient comprises
calculating the road safety coefficient of each zone in consideration of a road friction coefficient according to the road surface state information of each zone.

6. The method of claim 1, wherein the location information of each zone is relative location information and the location information of the vehicle is absolute location information, and the method further comprises
converting at least one of the location information of each zone and the location information of the vehicle before the estimating of the inter-vehicle safe distance situation.

7. The method of claim 6, wherein the service area is divided into a plurality of cells each having a cell ID, and the converting comprises:
converting location information of each zone into the cell ID; and
converting the location information of the vehicle terminal into the cell ID.

8. The method of claim 6, wherein the converting comprises
converting location information of each zone into absolute location information.

9. The method of any one of claim 1, wherein the road surface state information comprises at least one of a frozen state resulting from snow or freezing rain, a water screen state, a dry state, a wet state, and fog.

10. A system providing a vehicular safety service to a plurality of vehicle terminals installed in a plurality of vehicles, respectively, located in a service area, the system comprising:
a road sensor processing unit configured to receive road surface state information of each zone of the road in the service area from at least one road sensor located in the service area, and calculate a road safety coefficient of each zone by using the road surface state information of each zone of the road;
a vehicle information processing unit configured to calculate a traffic flow analysis coefficient of the service area based on location information and running information received from each of the plurality of vehicle terminals;
a safety determining unit configured to estimate a safe distance situation of each vehicle by using the road safety coefficient of each zone and the traffic flow analysis coefficient, and to determine a vehicle that has inadequate safe distance based on the estimated vehicle safe distance situation of each vehicle; and
an information providing unit configured to provide safe distance risk information to vehicle that has inadequate safe distance.

11. The system of claim 10, wherein the location information of each zone in the service area is relative location information and the location information of each vehicle is absolute location information, and the system further comprises
a location conversion unit configured to standardize the unit of the location information of each zone in the service area and the unit of the location information of each vehicle.

12. The system of claim 11, wherein the location conversion unit comprises
a relative location database storing location information of the service area according to an absolute location range and a relative location range.

13. The system of claim 12, wherein the service area is divided into a plurality of cells each having a cell ID, the location information of the service area comprises the cell ID, and the location conversion unit converts the location information of each zone and the location information of each vehicle into cell IDs.

14. The system of claim 13, wherein a horizontal section of each cell is set in consideration of an error range of the absolute location information, and a vertical section of each cell is set as the width of the lane.

15. The system of claim 11, wherein the location conversion unit converts the location information of each zone into absolute location information.

16. The system of claim 10, wherein the vehicle information processing unit determines whether or not each vehicle maintains a lane by using location information received from each of the plurality of vehicle terminals and determines a situation of the preceding and following vehicles in case of a vehicle running the same lane as that of a previous time, and the safety determining unit estimates a safe distance situation of each vehicle by additionally using the information regarding whether or not each vehicle maintains the lane and the situation of the preceding and following vehicles.

17. The system of claim 10, wherein the road sensor processing unit calculates the road safety coefficient of each zone in consideration of a road friction coefficient.
